(19) United States
(12) Patent Application Publication
(10) Pub. No.: US 2004/0136520 A1
(43) Pub. Date: Jul. 15, 2004

(54) Next generation gateway

(76) Inventors: David Ehreth, Healdsburg, CA (US); Art Bailey, Santa Rosa, CA (US); Aron Nopanen, Santa Rosa, CA (US); Marek Koziol, Penngrove, CA (US); John Przyblyski, Sebastopol, CA (US)

Correspondence Address: FISH & RICHARDSON P.C., 3300 DAIN RAUSCHER PLAZA, MINNEAPOLIS, MN, 55402, US

(21) Appl. No.: 10/675,585

(22) Filed: Sep. 29, 2003

Related U.S. Application Data
(60) Provisional application No. 60/453,724, filed on Sep. 27, 2002.

(51) Int. Cl. H04M 1/00; H04M 9/00

(52) U.S. Cl. 379/399.01

(57) ABSTRACT

Methods and apparatus implementing a technique for embedding telephony bearer resources in a digital loop carrier and communicating with a digital loop carrier in a manner which enables the combination of these resources and existing DLC capabilities to take on the characteristics of a next-generation access gateway.

This application claims the benefit of U.S. Provisional Application No. 60/453,724, filed on Sep. 27, 2002, which is incorporated by reference herein.

### BACKGROUND

This present specification relates to telecommunication.

As shown in FIG. 1, conventional end-office telecommunications systems, such as system 100, usually include a Class 5 switch (“C5”) 102, a digital loop carrier (“DLC”) 104, and end points such as a subscriber telephone 106 and a subscriber computer (not shown). Generally, the C5 102 provides the intelligence and resources to control the switching fabric of the DLC 104, thereby allowing the system to process calls.

### SUMMARY

The present specification describes methods and apparatus, including computer program products, for providing a next generation gateway.

In general, in one aspect, a method for communicating with a digital loop carrier includes receiving from a controlling entity line identification information specifying connectable end points in the digital loop carrier. The connectable end points represent one or more telephony bearer resources. The method further includes receiving from a controlling entity action information specifying one or more actions to be taken by the digital loop carrier with respect to the connectable end points specified by the line identification information. The method also includes generating a message that includes the line identification information and the action information. The method also includes sending the generated message to the digital loop carrier.

In general, in another aspect, a method for enabling a digital loop carrier to operate as a next generation gateway includes providing one or more telephony bearer resources in the digital loop carrier. The method further includes receiving line identification information specifying connectable end points in the digital loop carrier. The connectable end points include the one or more telephony bearer resources. The method also includes receiving action information specifying one or more actions to be taken by the digital loop carrier with respect to the connectable end points specified by the line identification information. The method also includes generating a message that includes the line identification information and the action information. The method also includes sending the generated message to the digital loop carrier.

In general, in another aspect, a system for enabling a digital loop carrier to operate as a next generation gateway includes one or more telephony bearer resources configured to be situated in the digital loop carrier. The system further includes an access switch that includes the intelligence to operate the telephony bearer resources and, furthermore, to control the digital loop carrier for telecommunication operations. The access switch is connected to the digital loop carrier and the telephony bearer resources.

Methods and apparatus described in the present specification can be implemented to realize one or more of the following advantages. A system for providing a next generation gateway allows a digital loop carrier to operate as a next generation gateway and to perform C5 functions. The system allows telephony bearer resources traditionally placed in a C5 to be placed in a DLC. The system advantageously includes its own intelligence for controlling a DLC and, consequently, does not need the intelligence of the C5, or of other controlling entities, for such operations. The system includes an adaptable and flexible message interface for interfacing with a DLC. The interface's adaptability allows the system to interface with any DLC, including those requiring customization. The interface's flexibility allows the system to connect any end points, including telephony bearer resources in the DLC. The system is vastly scalable. As a next generation gateway, a DLC improved by the system provides unification of traditional circuit-switched facilities with next generation packet telephony technologies. The system further provides the ability for partitioning of a DLC such that the DLC can continue to function in a conventional manner for some partitions and in a manner improved by methods and apparatus described in the present specification for other partitions. This capability facilitates incremental deployment of the described methods and apparatus in installed and functional systems with minimal impact on end-user service.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 shows a conventional telecommunication system.

FIG. 2 shows a telecommunication system for providing a next generation gateway.

FIG. 3 is a flow diagram showing an example call set up.

FIG. 4 is a flow diagram showing an example call tear down.

FIG. 5 is a flow diagram showing a redirect and restore event.

FIG. 6 is a flow diagram showing a call-not-directed event.

FIG. 7 is a flow diagram showing a redirect event when the system is operating in a host digital terminal configuration.

FIG. 8 is a flow diagram showing a redirect event when the system is operating in a point-to-point configuration.

FIG. 9 shows an example of a generic format for a 32 bit packed value representing a Line Id.

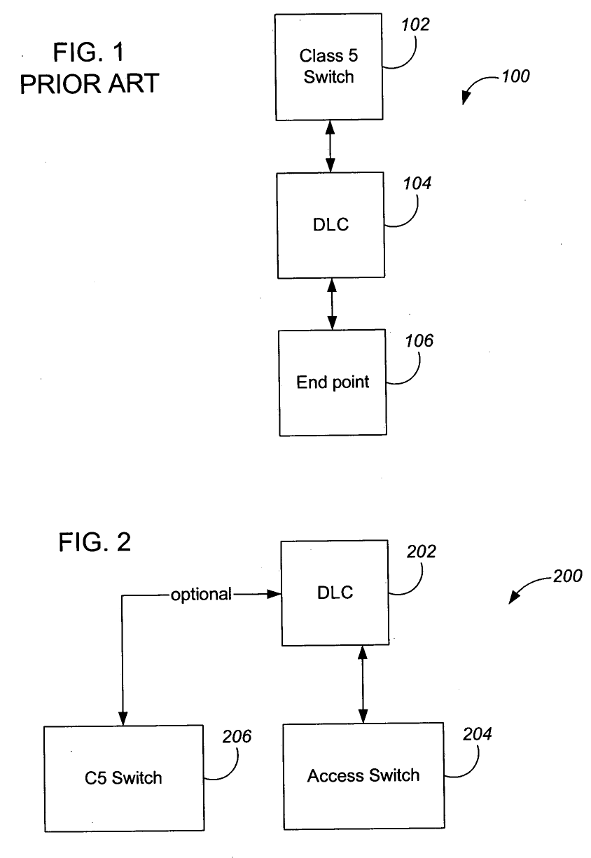

Like reference symbols in the various drawings indicate like elements.

### DETAILED DESCRIPTION

As shown in FIG. 2, a system for providing a next generation gateway can include a DLC 202 and an access switch 204. The DLC 202 is part of a traffic-bearing network and is connected to the access switch 204 for such operation. The DLC may or may not be connected to a C5 switch, such as the C5 switch 206. In either case, the DLC can co-exist as a peer to the C5 switch. The DLC 202 provides physical interfaces to both subscribers and trunk circuits through analog line cards such as those connecting to analog phone loops (i.e., POTS) and digital line cards such as those connecting T1 network interfaces. The DLC 202 also provides the flexible fabric that can be realized, for example, by a time slot interchanger (“TSI”), that connects subscribers to trunk circuits.

The DLC 202 can include bearer resources traditionally placed in a C5. Bearer resources are those involving traffic bearing channels (i.e., not signaling channels). Such resources include but are not limited to resources for detecting digit tones and generating call progress tones. Call progress tone generation includes but is not limited to generating a dial tone, a busy tone, a reorder tone, dual tone multi-frequency tones (“DTMF”), multi-frequency (“MF”) tones, and special information tones (“SIT”). The resources further include resources for detecting pulse dialing, multi-frequency tones and dual tone multi-frequency tones, for bridging multiple voice circuits together in a multi-party call, for loop signaling (such as loop-start, ground-start, loop-reverse battery, and E&M), for providing frequency-shift-keying (“FSK”) modem tones, and for providing telephony resources for services such as calling line identification and message waiting indication. The DLC 202 and the access switch 204 can include message interfaces and logic (neither shown) for managing signal messages exchanged between the DLC 202 and the access switch 204. The message interface allows the DLC 202 to communicate information such as hook status to the access switch 204 and, furthermore, to allow the access switch 204 to control the switching fabric within the DLC 202 for call processing. The messages include line identifications that are sufficiently flexible to identify any connectable end points, including telephony bearer resources added to the DLC 202 according to methods and apparatus described in the present specification. It is the line identification capability that allows traditional C5 bearer resources to be placed in the DLC 202, enabling the DLC to behave as a next generation access gateway controlled by an access switch which has no bearer connections to the DLC (i.e., only signaling connections).

In one implementation, the DLC 202 is a Litespan Digital Loop Carrier (“LS”) available from Alcatel, USA Inc. The access switch 204 is a V-Switch (“VS”), which is available from Westwave Communications, Inc. of Santa Rosa, Calif. (“Westwave”). The access switch 204 provides a message interface for interfacing with the LS. This interface is referred to in this specification as the V-Switch Gateway Control Protocol (“VGCP”) and includes messages that allow the flexibility of function in the LS. Furthermore, these messages allow handling of LS-specific requirements. Access switches similar to access switch 204 are described in U.S. patent application Ser. No. 09/809,338, filed Mar. 14, 2001, which application is hereby incorporated by reference.

General Communication Overview

Communication between the VS and the LS can be accomplished by a flow of messages, including proprietary messages, between the VS and any node in the subtended LS system. The VGCP can perform several functions, one of which is to allow the LS to communicate subscriber hook status to the VS. Another function of the VGCP is to allow the VS to manipulate the TDM (i.e., time division multiplexing) switching fabric within the LS to cross-connect endpoints as dictated by call processing functions in the access switch. The VGCP can also be used to perform audits, to allow the LS to send various notifications to the VS, and to perform certain debug functions. Notifications can include such functions as subscriber hook-status change, DTMF, MF and pulse-dial digit detection, and flash-hook and wink signals. Audits can include requests from the DLC for cross connect state information from the access switch for integrity checking and requests from the access switch to the DLC to ensure subscriber hook status integrity.

Physical Connection

The VS can be physically connected to the LS with one or more signaling links, for example, T1 and Internet-Protocol (“IP”) based links. These links can be transported from the LS to the VS by any manner of transport and connection equipment such as a digital cross connects, distribution frames, and Ethernet switches. Multiple signaling channels can be provided such that every node in the LS system can have a signaling link with the V-Switch. In the described implementations, there can be a maximum of six nodes in any LS system. Additional channels can be used to establish communications between the VS and other VS controlled devices residing in the LS, for example, a media gateway unit (“MGU”). Media gateway units include devices in the DLC that provide bearer capabilities such as tone generation, tone detection, and conference circuits. In order to provide facility and link protection, a second physical connection to the LS can be provided from the VS with the corresponding control links replicated on this second connection. As discussed, these connections can be IP connections or TDM connections on T1 facilities.

V-Switch Interface Group

The V-Switch interface group (“VSIG”) can be a logical equipment type in the LS. In one implementation, the VSIG provides a redundant pair of cross-connectable endpoints which are connected to signaling links from the V-Switch. It is over these signaling links that the V-Switch signals to an LS node. When the VSIG is used for signaling only and not for bearer traffic, the VSIG needs only two channels for terminating the main and protect links.

Protocol

The communication protocol between the VS and LS is, in one implementation, VGCP transported over a Link Access Procedure, D channel (“LAPD”). VGCP can be structured in a similar manner to Q.931. The transport protocol, in one implementation, is readily supported in the LS and allows a message handler in the LS to reuse existing error-detection and inter-process message-delivery systems. The VGCP can be an elegantly simple messaging protocol and leverages capabilities already existing in the LS (or DLC in general).

Alternatively, other communication protocols can be used to carry the same VGCP message payload and semantics. For example, ATM or IP over different physical channels can be used as long as the appropriate modifications to the message delivery system within the DLC are made such that the messages are delivered to the correct handler. The choice of transport protocol can be based on what best leverages existing infrastructure in the DLC.

Link and Facility Protection

In one implementation, the VGCP can provide support for signaling link protection. Configuring redundant links is not a requirement for system operation but may be required for a system carrying live traffic with 99.999% reliability requirements. In one implementation, the protection switching need be implemented at only the link level. Facility protection can be achieved as a result of actual system configuration. In one implementation, no explicit protocol support is needed for facility switching. Note that in implementations where both links reside on the same facility (e.g., Ethernet interface, T1 line, and so forth) there can be generally no facility protection available. The link protection methodology is described in the following paragraphs.

The following protection switching scheme details a simple but effective method for implementing link protection between the VS and a subtended entity such as a LS node.

In one implementation, the normal flow of call processing messages generally occurs only on an active link. The VS is responsible for using the protection switch message to define the active link. The protection switch message is permitted at any time and can be sent whenever there is a need to define an active link or synchronize the link status between the VS and LS. The response to a protection switch message is to first update the link status and then send the corresponding acknowledgment. When there is an outstanding protection switch message, the VS places any pending messages in a queue until the acknowledgment is received.

In one implementation, messages that are received on a standby link are an indication that there is a mismatch of link state between the VS and LS. Every message received on a standby link that is not a protection switch or a corresponding acknowledgement message results in a corresponding release message with a cause code of invalid link. These messages, typically call processing messages, are not processed by the LS. The release message is an indication to the VS that link synchronization is needed. At the same time, the release message indicates to the VS that a message needs to be retransmitted if the message is still valid. The component of the VS responsible for resolving link synchronization problems and the component responsible for retransmitting messages may be physically separated in the implementation, including the possibility that the former component be located in the LS itself.

VS-LS Messages

The following text describes one implementation of VS-LS messages. Tables 1-32 describes examples of the message structures. Alternatively, other VS-LS messages, message schemes, and message structure are possible.

The following message definitions apply to messages passed within the VS-LS interface. Receipt of any message not defined results in a release message with a cause code of “unimplemented message” being sent to the sender. The device enclosed in parentheses in each of the following message headings is used to indicate which device, VS or LS, is allowed to send the message being defined. Table 1 shows an example of message types defined for the VS-LS interface. Alternatively, the system can use other message types.

TABLE 1

VGCP Message Types = {
Link Protection Switch Message,
Link Protection Switch Acknowledge,
Info,
Connect,
Connect Acknowledgement,
Pump Up,
Release,
Hook Status Enquiry,
Hook Status,
Cross Connect Status Enquiry,
Cross Connect Status,
Data Audit,
Audit Response,
ECR Set Status,
ECR Status Report,
Cross Connect Request,
Cross Connect Report,
New Cross Connect,
Pump Up Request
}

The pair of VGCP links to a given node operates in an Active/Standby mode. In one implementation, the only messages that may be transmitted on the standby link are the protection switch message and its acknowledgement. The transmission of any other message on the standby link results in one of the two following responses. When the LS receives a message on the link designated as standby, the LS responds with a release message with a cause value of invalid link. The LS does not perform any additional processing of the message received. When the VS receives a message on the link it considers standby, the VS responds with a protection switch message on the link the VS considers active and queue any additional call processing messages until the acknowledge is received.

Link Protection Switch Message (VS)

In one implementation, the link protection switch message is used to facilitate a change from the current active link to the standby link or to confirm that a link is in fact active. Receipt of this message by the LS causes the link on which the message is received to transition to become active. When the protection switch message is received on a currently active link, the message is acknowledged and the link states remain unchanged. This action can be used by the VS to synchronize link status at power up or after a reset. Table 2 shows an example structure of a link protection switch message. Alternatively, other structures can be used.

TABLE 2

Message Format:
Header: MsgType = Link Protection Switch

Link Protection Switch Acknowledge (LS)

In one implementation, the link protection switch acknowledge message is sent by the LS as a response to a protection switch message. Receipt of this message indicates that the requested link protection switch has occurred and the respective link is now active and ready to handle call-processing messages. Table 3 shows an example structure of a link protection switch acknowledge message. Alternatively, other structures can be used.

TABLE 3

Message Format:
Header: MsgType = Link Protection Switch Acknowledge

Info Message (LS)

In one implementation, the info message is used by the LS to indicate subscriber hook status to the VS. The events that would typically generate this message are the detection of a subscriber going off hook or on hook. Table 4 shows an example structure of an info message. Alternatively, other structures can be used.

TABLE 4

```
Message Format:
    Header: MsgType = Info
    LineId
    HookStatus
```

Connect Message (VSG)

In one implementation, the connect message is used by the VS to command cross connect activities within the LS. The connect message is a multi-part message that includes line identifiers (line Id) and actions to be performed against them. The message may include up to four unique line ids and five actions. In one implementation, the action set currently defined only handles a maximum of two points but can be expanded as needed. Whenever possible, the VS follows the convention of placing the subscriber in the first line Id.

In one implementation, the interface element in the message serves two purposes. The first is to specify what type of interface the subscriber belongs to. This specification is needed to adapt to differences between line interfaces. For example, line signaling (AB or ABCD bits) is different for TR008 vs. GR303. VS interface subscribers can use GR303 signaling. The second purpose is to specify whether validation should be performed against the line Ids included in the message. Validation is specified during normal call processing. This feature causes the LS to check each line Id for conditions such as the presence of unequipped, out of service, or failed conditions. The presence of any of these conditions against any of the line Ids in the message results in a release message including the offending line Id and an appropriate cause code. In one implementation, if more than one line Id is affected, only the first line Id is reported in the release message. The original connect message is not processed. If the VS requires the message to be processed for the purpose of restoring a subscriber to idle, for example, then the original message is resent with the verify bit not set. This action causes the LS to skip validation and process the message. Table 5 shows an example structure of a connect message. Alternatively, other structures can be used.

TABLE 5

```
Message Format:
    Header: MsgType = Connect
    InterfaceType
    LineId[4] {up to 4 LineIds may be specified}
    Action[5] {up to 5 actions may be specified}
```

Connect Acknowledgement (LS)

In one implementation, the connect acknowledgement message is used to indicate successful receipt and execution of a connect message. Table 6 shows an example structure of a connect-acknowledgement message. Alternatively, other structures can be used.

TABLE 6

Message Format:
Header: MsgType = Connect Acknowledge

Pump Up Message (VSG)

In one implementation, the Pump Up message uses the same message structure as the one described for the Connect message. The semantics of the fields therein are also the same as in the Connect message. In one implementation, the only difference between the Connect and Pump Up messages is that the actions specified in the Pump Up message are to be executed only on the standby LS side. The purpose of this message is to allow for the ability to “pump-over” (i.e., transfer to) dynamic VS cross-connects to a newly inserted or reset standby LS side. As for the Connect message, the response in the successful case is a Connect Acknowledgement and in the failure case is a Release message. Table 7 shows an example structure of a pump up message. Alternatively, other structures can be used.

TABLE 7

```
Message Format:
    Header: MsgType = Pump Up
    InterfaceType
    LineId[4] {up to 4 LineIds may be specified}
    Action[5] {up to 5 actions may be specified}
```

Release Message (VSG, LS)

In one implementation, the release message is used to communicate an error condition that is the result of an inability to execute a commanded action, failed verification of an endpoint, or a need to abnormally terminate a call being processed. The cause code is used to indicate the nature of the condition. There are two formats for a Release message. The message may either specify a line Id if the error concerns a particular endpoint, or an Action if an error occurred while processing the action, or neither for all other conditions. Table 8 shows example structures of a release message. Alternatively, other structures can be used.

TABLE 8

```
Message Format:
    Header: MsgType = Release
    LineId
    Cause
or
    Header: MsgType = Release
Action
Cause
```

Hook Status Enquiry Message (VS)

In one implementation, the hook status enquiry message is used by the VS to request the current hook status of a given subscriber. The message facilitates the auditing of subscriber status. Table 9 shows an example structure of the hook status inquiry message. Alternatively, other structures can be used.

TABLE 9

```
Message Format:
    Header: MsgType = Hook Status Inquiry
    LineId
```

Hook Status Message (LS)

In one implementation, the hook status message includes hook status information pertaining to the line Id in the hook status enquiry. Table 10 shows an example structure of the hook status message. Alternatively, other structures can be used.

TABLE 10

```
Message Format:
    Header: MsgType = Hook Status
    LineId
    Hook Status
    Cause
```

Cross Connect Status Enquiry (VS)

In one implementation, the cross connect status inquiry message is used by the VS to check the presence or absence of a cross connect between two endpoints in the LS. Table 11 shows an example structure of the cross connect status enquiry message. Alternatively, other structures can be used.

TABLE 11

```
Message Format:
    Header: MsgType = Cross Connect Status Inquiry
    Source LineID
    Destination LineID
    Cross Connect Type
```

Cross Connect Status Message (LS)

In one implementation, the cross connect status message includes information specifying the presence or absence of a cross connect between the two endpoints in the cross connect status inquiry. Table 12 shows an example structure of the cross connect status message: Alternatively, other structures can be used.

TABLE 12

```
Message Format:
    Header: MsgType = Cross Connect Status
    Cross Connect Exists
```

Data Audit Message (VS)

In one implementation, the Data Audit message is used to initiate auditing of any data within the LS that is VS related and that is not audited by existing LS audit processing. For example, data structures in the LS used by VS controlled functionality may be audited to ensure data integrity. Table 13 shows an example structure of the data audit message. Alternatively, other structures can be used.

TABLE 13

Message Format:
Header: MsgType = Data Audit

Audit Response Message (LS)

In one implementation, the Audit Response message is sent in response to the Data Audit message. The Cause element indicates the success or failure of the audit cycle. For example, the message CauseNormClear is sent following a successful audit cycle. Table 14 shows an example structure of an audit response message. Alternatively, other structures can be used.

TABLE 14

```
Message Format:
    Header: MsgType = Audit Response
    Cause
```

ECR Set Status Message (LS)

Enhanced Call Redirect (“ECR”) is an application in the access switch enabled in accordance with methods and apparatus described in the present specification, in which C5-controlled subscribers may have their call processing taken over by the V-Switch according to specific dialing and routing rules. In one implementation, the ECR Set Status message is sent by the LS to request that V-Switch ECR functionality be turned on or off for subscribers in the node sending the message. If a message requesting that ECR be turned off is sent from a LS COT, any ECR-related connections required to support subscribers in other nodes will still be made.

The VS can respond to an ECR Set Status message from a LS with an ECR Status Report message. The response can include the current status of ECR for that node. In the success case, the status matches that of the request message. If the request were to fail, however, the response can indicate that the status of ECR for the node has not changed.

The LS can place a value in the Status field requesting that the VS return the current status of ECR for the node without affecting that status. Table 15 shows an example structure of an ECR set status message. Alternatively, other structures can be used.

TABLE 15

```
Message Format:
    Header: MsgType = ECR Set Status
    ECR Status
```

ECR Status Report Message (VS)

In one implementation, the ECR Status Report message is sent by the VS in response to an ECR Set Status message. The message includes the current state of ECR for the VS. Table 16 shows an example structure of an ECR status report message. Alternatively, other structures can be used.

TABLE 16

```
Message Format:
    Header: MsgType = ECR Status Report
    ECR Status
```

Cross Connect Request Message (LS)

In one implementation, the Cross Connect Request message is sent by the LS to request a “snapshot” of VS dynamic cross-connects at the time the message is received. The VS responds to the Cross Connect Request message with a series of Cross Connect Report messages indicating the current set of dynamic cross-connects. The request message includes a type element indicating the classes of cross-connects to report. Table 17 shows an example structure of a Cross Connect Request message. Alternatively, other structures can be used.

TABLE 17

```
Message Format:
    Header: MsgType = Cross Connect Request
    Cross Connect Report Type
```

Cross Connect Report Message (VS)

In one implementation, the Cross Connect Report message is sent by the VS to report the location of one or more dynamic VS cross-connects; the message can be sent in response to a Cross Connect Request message. This is a variable-length message that can include as many cross-connects as permitted by size restrictions.

Each connection in the message can be defined by a sequence of three elements—two Channel Identification elements followed by one type element. The Channel Identification elements indicate the two endpoints of the specified cross-connection, and the type element indicates the characteristics of that cross-connect. For simple cross-connects, the first Channel Identification element indicates the source, while the second Channel Identification element indicates the destination.

The Cross Connect Report message can be terminated by a Batch Info element that indicates the current batch of cross-connects being reported, as well as an indication of whether more batches are to follow. A batch of cross connects can be defined as a set of cross-connects reported in a single Cross Connect Report message. In one implementation, there is no acknowledgement to this message. Table 18 shows an example structure of a Cross Connect Report message. Alternatively, other structures can be used.

TABLE 18

```
Message Format:
    Header: MsgType = Cross Connect Report
    Source LineID
    Destination LineID
    Cross Connect Type
    .
    . {previous three elements may repeat}
    .
    Batch Info
```

New Cross Connect Message (LS)

In one implementation, the New Cross Connect message is sent by the LS to indicate that a new cross-connect has been provisioned to a SONET DS0 on the node. SONET DS0's represent bandwidth between nodes of the LS that can be shared between the VS and the C5 switch controlling the LS. (Note that the LS may be partitioned so that some subscribers are controlled by the VS and others by the C5. With such a configuration, SONET bandwidth between LS nodes can be a shared resource. The VS needs to know when portions of this bandwidth have been used by the C5 to prevent collisions. In the case where the VS is the only controlling switch for the LS, this bandwidth can be entirely managed by the VS and this message is not used.) The indication can be provided since the SONET DS0 may have been in the pool of available bearer channels between LS nodes. The Channel Identification element can indicate the SONET DS0 involved in the cross-connect. In one implementation, there is no acknowledgement to this message. Table 19 shows an example structure of a new Cross Connect Report message. Alternatively, other structures can be used.

TABLE 19

```
Message Format:
    Header: MsgType = New Cross Connect
    SONET Point
```

Pump-Up Request Message (LS)

In one implementation, the Pump-Up Request message is sent by the LS to request a V-Switch pump-up. The message is sent when a standby LS side becomes ready to accept V-Switch dynamic cross-connects. At this point, any existing V-Switch dynamic cross-connects need to be propagated to the standby LS side using Pump-Up messages. In one implementation, there is no acknowledgement to this message. Table 20 shows an example structure of a Pump-Up Request message. Alternatively, other structures can be used.

TABLE 20

Message Format:
Header: MsgType = Pump Up Request

Message Constructs

Each message defined for the VGCP can be decomposed into a number of distinct elements. Some elements, such as the message header, are common to some or all messages while other elements are unique to a particular message.

Correlation Tag

In one implementation, the correlation tag is included within the message header and provides the VS with a mechanism for associating responses from the LS with commands from the VS. In one implementation, the correlation tag includes three parts. The first byte denotes the length, in bytes, of the tag and is fixed at 0×08. The next four bytes represent a single 32-bit tag with the bytes in descending order of precedence. The remaining four bytes represent another 32-bit tag with the bytes in descending order of precedence.

In one implementation, correlation tag values originate in the VS. The result is that messages originating from the LS will set the tag bytes to 0×00. Messages from the VS include valid tag values as determined by the VS. Responses to those messages can include the tag values sent in the command. Table 21 shows an example structure of a correlation tag. Alternatively, the system can use other structures to provide correlation between the VS and LS.

TABLE 21

```
Message Element: Call Reference
    Length of Tag
    Correlation Tag Values
```

Message Header

In one implementation, the message header is the first part of every message. The message header can specify the message name and type. Table 22 shows one example structure of the message header. Alternatively, the system can use other structures of headers.

TABLE 22

Message Element: Header

Protocol Discriminator
Message name
Message Type

Channel Identification Element

In one implementation, the channel identification element identifies a specific DS0 within the LS system and is also referred to as a line Id. The DS0 is often associated with a subscriber, telephony bearer resource (MGU) or SONET VT DS0. (MGU, in this case, includes any of the family of Westwave telephony bearer resource line cards in the LS, for example, a VMGU, VMGT, VMGI, and so forth.) The line identifier can be a four-byte encoded value. The coding and decoding of this value is dealt with later in this document. Byte1 is usually the most significant byte. The channel identification element can include an element identification, a length, and the line Id value. Table 23 shows one example structure of a channel identification element. Alternatively, the system can use other structures identifying a specific DS0.

TABLE 23

Message Element: Channel ID

Byte Length
LineIDs

Cause Element

In one implementation, the cause element is used to indicate the success or failure of a requested action as well as provide some indication of why the action failed if failure was the result. This element can include information specifying a length of the element, a cause of some action (e.g., a problem that causes a line to be dropped), where the cause is occurring, and the identification of the offending message. Table 24 shows an example structure of a cause element. Alternatively, other structures of this element can be used.

TABLE 24

Message Element: Cause

Byte Length
Cause Location
Value indicating Cause
Identification of the offending message

Cause Code Values

In one implementation, cause code values specify one or more causes of some action in the system. Each code specifies a cause. Additional cause codes can be added if appropriate. Table 25 lists some causes. Alternatively, other and additional causes can be used.

TABLE 25

Normal Clearing or Success
Destination Out of Service
Channel Unavailable
Temporary Failure
Line Unit Unavailable
Invalid Link
Invalid Link Identifier
Message Unimplemented
Provisioned X-Conn at point
Underlying equipment unequipped
Underlying equipment failed

Switch Hook Info Element

In one implementation, the switch hook info element is used to indicate hook status for a subscriber. Table 26 shows an example structure of a hook status element. Alternatively, other structures can be used.

TABLE 26

Message Element: Switch Hook Info

Element ID
Byte Length
Value indicating Hook Status

Interface Info Element

In one implementation, the interface element is a single byte element that is used to convey the type of subscriber interface being addressed. For example, the interfaces may be GR303, TR008, and VS. The interface info element can be required because the system uses existing DLC line card resources for supporting subscriber lines. The line cards will typically have been designed to be used by traditional DLC protocols such as TR008 and/or GR303. When the C5 switch is not present to provide the line signaling required by these line cards, the access switch (the VS in this case) must know which type of signaling to provide. The interface info element can follow the coding rules specified for a single octet element with variable data as specified in Q.931 paragraph 4.5.1. The high nibble can serve as both the element Id, with a value of 0×e0, and the verify bit which resides in the least significant bit. The verify bit can be used to specify if any error checking is to be performed against the line Ids in the connect message. In one implementation, a value of 0×e0 means that no error checking is to be performed. A value of 1×F0 will command the LS to check each line Id included in the connect message for out of service, unequipped, or failed conditions. The low nibble can be used to specify the interface type. The value for GR303 is 0×05. The value for TR008 Mode 1 is 0×0a. The value for VS subscribers is 0×07. A VS subscriber is defined as any subscriber to whom the VS is generally responsible for providing primary dial tone. Table 27 shows an example structure of the Interface Info element. Alternatively, other structures can be used.

TABLE 27

Message Element: Interface

Interface Type

Action Info Element

In one implementation, the action info element is used to communicate what types of cross connect actions are to be performed against the line Ids included in the command messages from the VS. The actions are a one byte, enumerated, value. The intent is to provide the connection manager in the VS with a generic means to establish any desired cross connect in the LS by allowing a single message to command one or more actions against the specified endpoints within the LS.

In one implementation, each action byte can be a self-contained message that communicates what type of cross connect to make, the need to idle an endpoint, and so forth. By combining line Ids and actions, the VS commands several activities with a single message. Such a combination is needed because it is sometimes necessary for the LS to make several changes to the TDM fabric in immediate succession in order to provide a seamless transition during a commanded operation. Table 28 shows an example structure of an action info element. Alternatively, other structures can be used.

TABLE 28

Message Element: Action Info

Element ID
Byte Length
Byte Mode
Value specifying an Action

Action Byte Definitions

In one implementation, each enumerated action byte can specify a unique action or set of actions to be applied to the corresponding line Ids included in the connect message. Some of the actions reference “1sDest” or “2s Dest” (and so forth) and this brings to light one last concept. A's destination or B's destination can be used when the VS does not have knowledge of where a given endpoint is cross connected because of a dynamic situation such as GR303. (Note that the cross connects in question here are not VS controlled, but rather are those created by the C5 using existing DLC protocols (for example, TR008 or GR303).) In this instance, it may be necessary for the LS to determine the destination of an endpoint.

One use of this type of action would be when a line Id is to be redirected from a GR303 interface and the connection to the C5 needs to be idled. In implementations where the VS has no knowledge of the connection commanded by the C5, the VS cannot specify the opposite end point directly. The VS does know the line Id of the subscriber and can use that endpoint as long as it is understood that the action is to be taken against where the endpoint is going as opposed to the end point itself.

Table 29 enumerates the atomic actions that can be commanded for one implementation. Although some action can be decomposed into a combination of other actions, they are distinctly defined as a matter of convenience for both the VS and the LS. The last action defined deserves special attention. This action is a special value that can allow the VS to specify to the LS that a redirect event is concluding and the other actions included in the action list will restore the subscriber to its original state. The FinalAction enumerated shall, in the described implementation, always be the last action in the list.

TABLE 29

Connect LineId1 to LineId2
Connect LineId1 to LineId3
Connect LineId2 to LineId1
Connect LineId2 to LineId3
Connect LineId3 to LineId1
Connect LineId3 to LineId2
Disconnect LineId1 from LineId2
Disconnect LineId1 from LineId3
Disconnect LineId2 from LineId3
Move Id1 from Id2 to Id3
Move Id1 from Id3 to Id2
Move Id2 from Id1 to Id3
Move Id2 from Id3 to Id
Move Id3 from Id1 to Id2
Move Id3 from Id2 to Id1
Idle Id1 xconn destination
Idle Id2 xconn destination
Idle Id3 xconn destination
Restore Id1 xconn destination
Restore Id2 xconn destination
Restore Id3 xconn destination
Connect LineId1 to LineId4
Connect LineId2 to LineId4
Connect LineId3 to LineId4
Disconnect LineId1 from LineId4
Disconnect LineId2 from LineId4
Disconnect LineId3 from LineId4

ECR Status Element

In one implementation, the ECR Status element is a single byte element that is used to indicate the status of ECR for the node. This element can follow the coding rules specified for a single octet element with variable date as specified in Q.931 description above. The high nibble serves as the element identification, with a value of 0×70. The low nibble is used to specify the ECR status. A value of 0×1 indicates/requests that ECR is/be made inactive (off) for the node. A value of 0×3 indicates/request that ECR is/be made active (on) for the node. A value of 0×5 may only be place in messages originated by the LS; the 0×5 value serves to request that the current ECR status be returned by the VS without changing that status. Table 30 shows an example structure of an ECR status message. Alternatively, other structures can be used.

TABLE 30

Message Element: ECR Status

Element ID
Value indicating ECR Status

Cross Connect Type Element

In one implementation, the Cross Connect Type element is a single byte element that is used to indicate the type of cross-connect being requested or reported. The cross connect type element can follow the coding rules specified for a single octet element with variable date as specified in Q.931 description above. The high nibble can serve as the element Id, with a value of 0×C0. The low nibble can be used to specify the cross-connect type. The low nibble can be a bitmap allowing to specify any combination of simplex, duplex, access switching, and ECR connections.

In one implementation, at least one bit of the first pair and one bit of the last pair must be set to define a valid cross-connect. If the cross connect type element is being used to request a set of cross-connects, one or both bits in each pair may be set. If the element is being used to identify a single cross-connect, exactly one bit in each pair must be set. Table 31 shows one example structure of a cross-connect-type element. Alternatively, other structures can be used.

TABLE 31

Message Element: Cross Connect Type

Element ID
Values indicating Cross Connect Type

Batch Info Element

In one implementation, the batch info element is used to indicate information about batches of cross-connects being reported in an Cross Connect Report message. Table 32 shows an example structure of the batch info element. Alternatively, other structures can be used.

TABLE 32
Message Element: Batch Info

Element ID
Byte Length
Number of Current Batch

Message Flows

In one implementation, the flow of messages between the VS and LS can be fairly simple and intuitive based on an understanding of the task and the available messages. The following sections outline the message flows for the most common tasks needed to provide line side redirect capability. These message flows are by no means all inclusive but are intended to provide an example of message usage.

Generally, the diagram on the right side of each figure depicts the state of VS dynamic cross-connects in the LS. The box labeled ‘V’ is one of the VMG cards described above. (A VMG card, whether it is a VMGU, VMGT, or VMGI, is referred to in this specification as a VMGx.) The numbered points correspond to the points specified in the messages. The flow diagram to the left represents the message exchange between the VS and the LS COT and RT. The direction of the arrow indicates the sender and receiver of the message. The column on the far left indicates the basic activity that is occurring.

Messages are also sent from the VS to a VMGx to command the VMGx to, for example, collect DTMF digits and make internal connections. These messages are carried on dedicated signaling links between the VS and the VMGx. No processing of these messages is performed by the LS so the messages are not included in the call flows.

Access Switching Call Setup and Tear Down

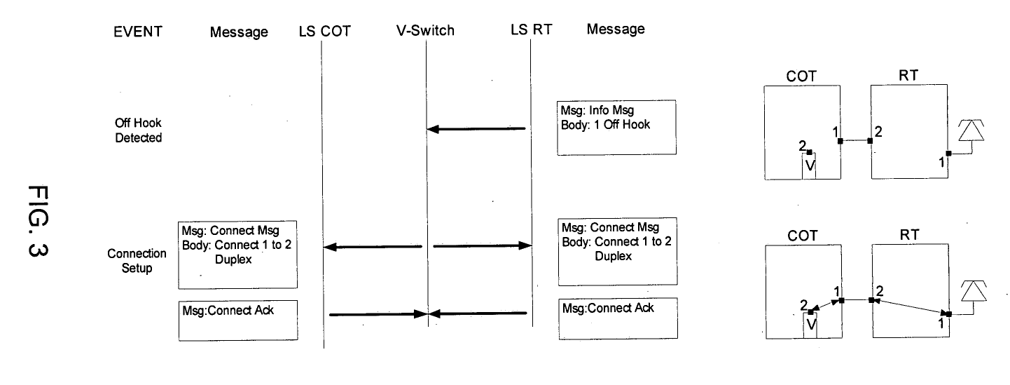

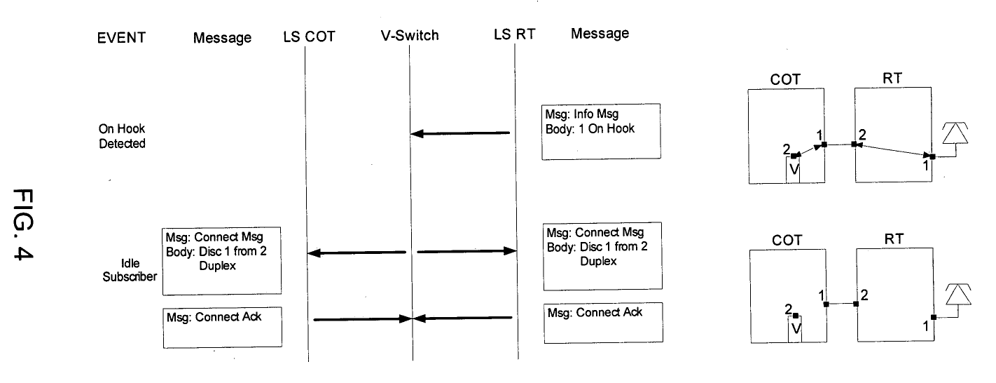

FIG. 3 illustrates an example call setup. FIG. 4 illustrates an example call tear down.

GR303 Point to Point

A point-to-point system is the most commonly deployed DLC configuration. The point-to-point configuration delivers subscriber services via a switch interface card in the LS COT connected to a subscriber interface card in a LS RT.

GR303 Redirect and Restore Event

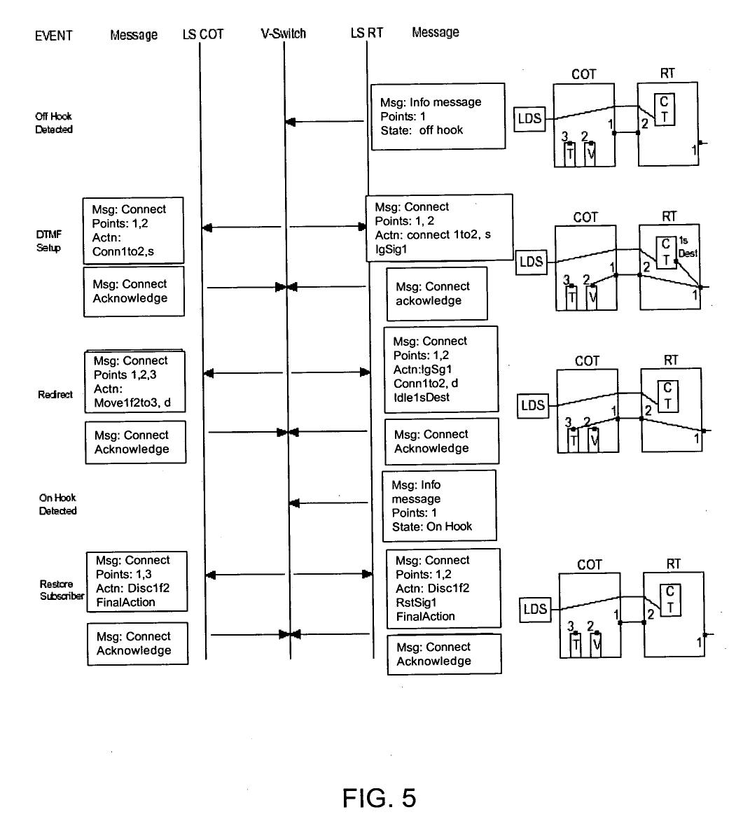

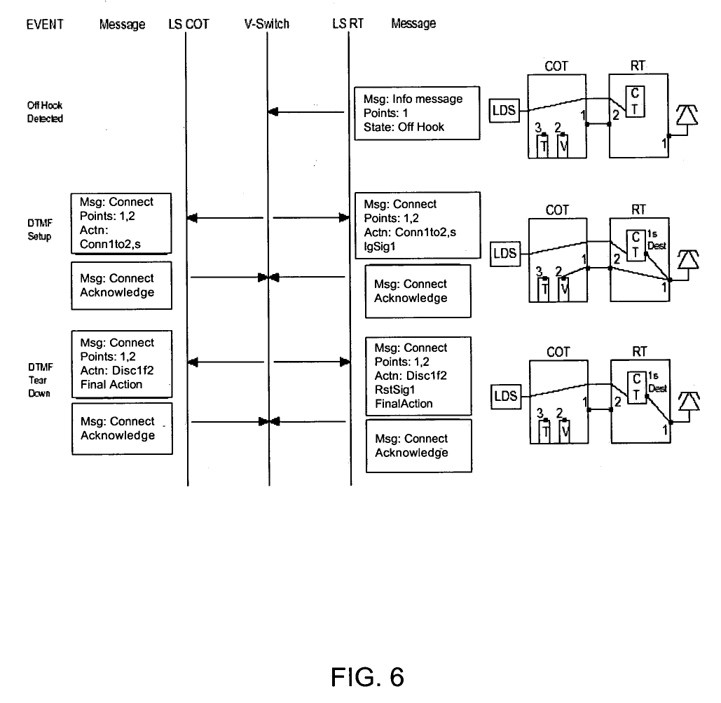

FIG. 5 is a flow diagram showing ECR redirect and restore events. FIG. 5 illustrates the message interaction between the VS and LS during a typical line side ECR redirect and restore. The points indicated in the message boxes refer to the block diagrams but the associated actions refer to the order that the points are included in the message. FIG. 6 is a call flow diagram showing a call-not-directed event.

GR303 HDT

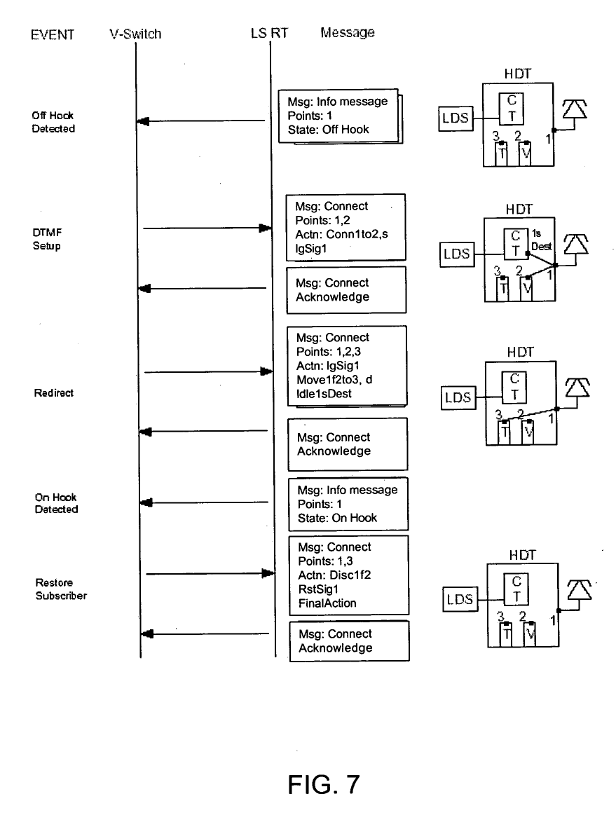

A Host Digital Terminal (“HDT”) configuration can refer to a single node DLC system in which both the switch interface and subscriber interface cards reside in the same node. FIG. 7 is a flow diagram showing a redirect event. Message flows where calls are not redirected can be ascertained from FIGS. 5, 6, and 7.

TR008 Point to Point

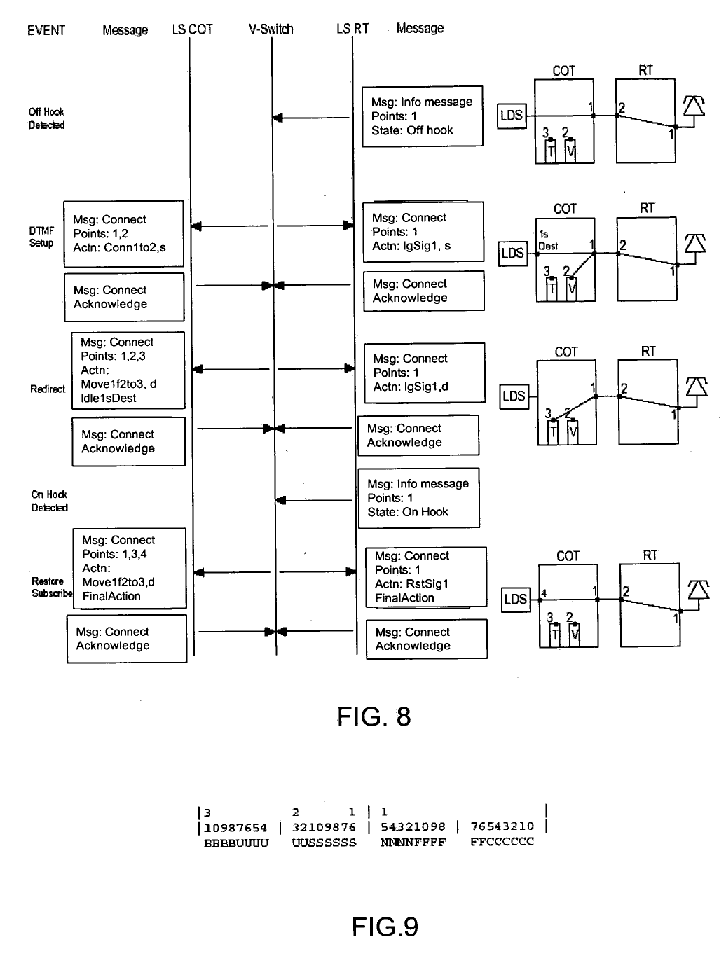

FIG. 8 illustrates the exchange of messages between the VS and LS for a TR008 configuration. Because a TR008 subscriber has a nailed-up, dedicated path to the switch, the message flows for a this configuration are similar to the HDT configuration above. A primary difference is that, in the HDT configuration, the off hook and on hook information messages come from the COT.

Line Identifier Encoding

In order for the VS to control actions within the LS, it is necessary to have a method for specifying a particular DS0 within the system. The described format of the line Ids can be flexible enough to be able to denote any cross-connectable point in the LS system. The format can also be compact to preserve bandwidth in the signaling links. In one implementation, the following distinct DS0 types are identified. (Telephony bearer resources on MGU cards are accessed via channel bank DS0's.)

Channel Bank DS0

Optical Network Unit (ONU)DS0

Electrical Network Unit (ENU)DS0SONET VT DS0

FIG. 9 shows an example of one format for a 32 bit packed value representing the Line Id. Alternatively, other formats can be used. The following defines terms of FIG. 9.

F=Facility

C=Channel

B=Bank

U=Network Unit ID, this is not needed for equipment residing in channel banks.

S=Slot within the specified bank.

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. The essential elements of a computer are a processor for executing instructions and a memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

The invention has been described in terms of particular embodiments. Other embodiments are within the scope of the following claims. For example, steps of the invention can be performed in a different order and still achieve desirable results. The implementation approach will typically be influenced by the architecture of the DLC in question. For example, if the DLC does not have a suitable Ethernet interface over which to carry VGCP signaling, a T1 may be used. If the DLC has a central processor with “dumb” line cards, the invention would typically be implemented centrally. A DLC architecture based on a distributed processing model might suggest a distributed implementation of this invention.

What is claimed is:

1. A method for communicating with a digital loop carrier, the method comprising:
receiving from a controlling entity line identification information specifying connectable end points in the digital loop carrier, the connectable end points representing one or more telephony bearer resources;
receiving from a controlling entity action information specifying one or more actions to be taken by the digital loop carrier with respect to the connectable end points specified by the line identification information;
generating a message that includes the line identification information and the action information; and
sending the generated message to the digital loop carrier.

2. The method of claim 1, wherein receiving line identification information includes:
receiving line identification information that specifies a connectable end point in the digital loop carrier by specifying any combination of a physical device, a node, a facility, a channel and a telephony bearer resource in the digital loop carrier.

3. The method of claim 2, wherein receiving line identification information includes:
receiving line identification information that further specifies a bank, a network unit, and a slot of the digital loop carrier such that the endpoint is unambiguously identifiable.

4. The method of claim 3, wherein generating a message includes:
generating a message that includes the line identification information in a channel identification element of the message.

5. The method of claim 1, wherein sending a message includes sending the message over an active link, the method further comprising:
providing a standby link as a backup to the active link.

6. The method of claim 5, wherein receiving action information includes:
receiving action information specifying a link-protection-switch action that causes the digital loop carrier to switch the link on which the message is received from standby to active status.

7. The method of claim 6, further comprising:
receiving acknowledgement from the digital loop carrier that the digital loop carrier has switched the link on which the message is received from standby to active status.

8. The method of claim 1, wherein receiving action information includes:
receiving action information requesting hook status.

9. The method of claim 1, wherein:
receiving action information includes receiving action information specifying multiple actions to be executed by the digital loop carrier;
receiving line identification information includes receiving line identification information that specify multiple connectable end points; and
the generated message results in the establishment of cross connects between endpoints in the digital loop carrier in accordance with the action and the line identification information.

10. The method of claim 9, further comprising:
receiving acknowledgement from the digital loop carrier that the digital loop carrier has received and executed the message.

11. The method of claim 9, wherein sending a message includes sending the message over an active link, the method further comprising:
providing a standby link as a backup to the active link; and
sending the message to the digital loop carrier over the active link, wherein the message causes the digital loop carrier to replicate dynamic cross connects to the standby side.

12. The method of claim 1, wherein receiving action information includes:
receiving action information specifying a disconnect action that causes the digital loop carrier to release connectable end points identified by the line identification information.

13. The method of claim 1, wherein receiving action information includes:
receiving action information that queries for the presence or absence of a cross connection between the connectable end points specified by the line identification information, the connectable end points being cross connectable end points.

14. The method of claim 13, further comprising:
receiving a report from the digital loop carrier specifying the hook status of the connectable end point when the connectable end point is a subscriber end point.

15. The method of claim 1, wherein receiving action information includes:
receiving action information reporting locations of the cross connection currently established.

16. The method of claim 1, wherein generating a message includes:
generating a message that includes a correlation tag and message header information.

17. A method for enabling a digital loop carrier to operate as a next generation gateway, comprising:
providing one or more telephony bearer resources in the digital loop carrier;
receiving line identification information specifying connectable end points in the digital loop carrier, the connectable end points including the one or more telephony bearer resources;
receiving action information specifying one or more actions to be taken by the digital loop carrier with respect to the connectable end points specified by the line identification information;
generating a message that includes the line identification information and the action information; and
sending the generated message to the digital loop carrier.

18. The method of claim 17, wherein providing one or more telephony resources includes:
providing telephony resources for tone detection and generation.

19. The method of claim 18, wherein providing telephony resources for tone detection and generation includes:
providing telephony resources for detecting and generating pulse dialing, multi-frequency tones and dual tone multi-frequency tones.

20. The method of claim 18, wherein providing telephony resources for tone detection and generation includes:
providing telephony resources for generating a dial tone, a busy tone, a reorder tone, dual tone multi-frequency tones, multi-frequency tones, and special information tones.

21. The method of claim 17, wherein providing one or more telephony resources includes:
providing telephony resources for bridging multiple voice circuits together in a multi-party call.

22. The method of claim 17, wherein providing one or more telephony resources includes:
providing telephony resources for loop signaling.

23. The method of claim 22, wherein providing telephony resources for loop signaling includes:
providing resources for performing loop-start, ground-start, loop-reverse battery, and E&M signaling.

24. The method of claim 17, wherein providing one or more telephony resources includes:
providing frequency-shift-keying modem tones.

25. The method of claim 24, wherein providing frequency-shift-keying modem tones includes:
providing telephony resources for delivering calling-line-identification information and message waiting indication status changes.

26. A system for enabling a digital loop carrier to operate as a next generation gateway, the system comprising:
one or more telephony bearer resources configured to be situated in the digital loop carrier; and
an access switch that includes the intelligence to operate the telephony bearer resources and, furthermore, to control the digital loop carrier for telecommunication operations, the access switch being connected to the digital loop carrier and the telephony bearer resources.
